(19) United States
(12) Patent Application Publication
(10) Pub. No.: US 2025/0341057 A1
(43) Pub. Date: Nov. 6, 2025

(54) DECORATIVE PAPER, DECORATIVE BOARD, AND METHODS FOR PRODUCING DECORATIVE PAPER AND DECORATIVE BOARD

(71) Applicant: TOPPAN HOLDINGS INC., Tokyo (JP)

(72) Inventors: Chiho HARADA, Tokyo (JP); Kengo HOZUMI, Tokyo (JP)

(73) Assignee: TOPPAN HOLDINGS INC., Tokyo (JP)

(21) Appl. No.: 19/265,921

(22) Filed: Jul. 10, 2025

Related U.S. Application Data
(63) Continuation of application No. PCT/JP2024/000176, filed on Jan. 9, 2024.

(30) Foreign Application Priority Data
Jan. 12, 2023 (JP) 2023-003028
Feb. 7, 2023 (JP) 2023-016690

(51) Int. Cl. D21H 19/66; D21H 19/24; D21H 19/36; D21H 19/82

(52) U.S. Cl. CPC D21H 19/66; D21H 19/24; D21H 19/36; D21H 19/826

(57) ABSTRACT

Decorative paper includes: a base layer; a design print layer provided on the upper side of the base layer, and an aesthetic resinous layer with excellent design properties disposed on the upper side of the design print layer, and includes a coating portion that is coated, and micropores that are not coated and which are disposed surrounded by the coating portion.

### CROSS-REFERENCE TO RELATED PATENT APPLICATIONS

The present application is a Bypass Continuation of International Patent Application No. PCT/JP2024/000176, filed Jan. 9, 2024, which claims priority to and the benefit of Japanese Patent Application No. 2023-003028, filed on Jan. 12, 2023, and Japanese Patent Application No. 2023-016690, filed on Feb. 7, 2023. The contents of these applications are hereby incorporated by reference herein in their entireties.

### TECHNICAL FIELD

The present invention relates to a decorative paper, a decorative board, and methods for producing the decorative paper and decorative board.

### BACKGROUND

Conventionally, decorative boards that are formed by impregnating a decorative paper with a heat-curable resin, such as a melamine resin, and then curing the impregnated heat-curable resin, are decorative boards with high surface hardness, and excellent stain resistance, wear resistance, heat resistance, water resistance, and the like. For this reason, decorative boards formed by impregnating a decorative paper with a heat-curable resin are used as the surface material of furniture such as desks, or fixtures such as store counters. Furthermore, there are examples of decorative paper and decorative boards in which the gloss of a surface resin layer is adjusted by using a matting agent or the like, to impart a visual three-dimensional effect to the surface of the decorative paper or decorative board.

The decorative paper for a resin-impregnated decorative board and the resin-impregnated decorative board described in PTL 1 are an example of a decorative paper that has been subjected to gloss adjustment, and a decorative board in which the decorative paper has been impregnated with a resin. The decorative paper for a resin-impregnated decorative board and the resin-impregnated decorative board described in PTL 1 include a base paper, a design pattern layer formed by printing a design pattern on the base paper, and a liquid-repellent cured film provided on the design pattern layer. The liquid-repellent cured film consists of a first liquid-repellent cured film that covers the entire design pattern layer, and a second liquid-repellent cured film provided on a portion of the first liquid-repellent cured film, and because the first liquid-repellent cured film and the second liquid-repellent cured film have different gloss (glossiness), the decorative paper for a resin-impregnated decorative board and the resin-impregnated decorative board described in PTL 1 have excellent design properties that have been subjected to gloss adjustment.

However, in the decorative paper for a resin-impregnated decorative board and the resin-impregnated decorative board described in PTL 1, there is a concern that the liquid-repellent cured film may soak into the base paper. As a result, impregnation of the decorative paper with the resin is poor, and the time required for the step of impregnating the impregnating resin into the decorative paper increases, which may result in poor processing suitability. Furthermore, in a case where the processing suitability of the step of impregnating the impregnating resin is to be improved, it is necessary to reduce the coating amount of the liquid-repellent cured film in order to reduce the amount of the liquid-repellent cured film that soaks into the base paper, and there is a concern that the degree of freedom with which the liquid-repellent cured film can be disposed will be reduced, resulting in an inferior design.

In addition, a decorative sheet and a decorative board provided with the decorative sheet described in PTL 2 include a decorative layer provided on a paper substrate, a release layer provided on the decorative layer, the release layer being formed to match a region of a design pattern provided in the decorative layer that requires low gloss, and a surface layer having high gloss that is formed in a region adjacent to the release layer. As a result, a design that has been subjected to gloss adjustment is obtained due to the difference in gloss between the release layer and the surface layer. Also, the surface layer is formed of a melamine resin that has been impregnated and cured in the decorative sheet.

Further, the decorative sheet and the decorative board provided with the decorative sheet described in PTL 2 include coating layers between the surface layer and the release layer and decorative layer, and the design properties can be maintained by suppressing the permeation of the release layer into the paper substrate with the coating layer. However, there is a concern that the coating layer may not only inhibit the release layer from soaking into the paper substrate, but also the impregnation of the impregnating resin, and as a result, the time required for the step of impregnating the impregnating resin into the decorative paper increases, which may result in poor processing suitability.

### CITATION LIST

### Patent Literature

[PTL 1] JP 2018-176484 A; [PTL 2] JP 2019-64120 A.

### SUMMARY OF THE INVENTION

### Technical Problem

In view of the circumstances described above, the present invention has an object of providing a decorative paper and decorative board having excellent design properties, and processing suitability in a step of impregnating an impregnating resin, and methods for producing the decorative paper and decorative board.

### Solution to Problem

In order to solve the above problem, the present invention proposes the following means.

A first aspect of the present invention is a decorative paper including: a base layer; a design print layer provided on an upper side of the base layer; and an aesthetic resinous layer with excellent design properties disposed on an upper side of the design print layer, the aesthetic resinous layer having a coating portion that is coated in a coating area, and micropores that are not coated, in which an area ratio of the coating portion to the design print layer is 5% or more and 60% or less.

A second aspect of the present invention is the decorative paper according to the first aspect, wherein the aesthetic resinous layer contains a heat-curable resin, an ultraviolet-curable resin, or an ionizing radiation-curable resin.

A third aspect of the present invention is the decorative paper according to the second aspect, wherein the area ratio of the coating portion of the aesthetic resinous layer to the design print layer is 10% or more and 40% or less.

A fourth aspect of the present invention is the decorative paper according to the third aspect, wherein the aesthetic resinous layer is disposed to match a design of the design print layer.

A fifth aspect of the present invention is a decorative board including: the decorative paper according to any one of the first to fourth aspects; and an impregnating resin that is impregnated and cured in the decorative paper.

A sixth aspect of the present invention is a method for producing a decorative paper, including: a design printing step for forming a design print layer; and a resin coating step for forming an aesthetic resinous layer with excellent design properties, in which an area ratio of a coating portion to the design print layer is 5% or more and 60% or less.

A seventh aspect of the present invention is the method for producing a decorative paper according to the sixth aspect, wherein in the resin coating step, the aesthetic resinous layer is formed such that the area ratio of the coating portion of the aesthetic resinous layer to the design print layer is 10% or more and 40% or less.

An eighth aspect of the present invention is a method for producing a decorative board, comprising: the method for producing a decorative paper according to the sixth or seventh aspect; a resin impregnating step for impregnating the decorative paper with an impregnating resin; and a pressing step for curing the impregnating resin.

A ninth aspect of the present invention is a decorative paper comprising: a base layer; a design print layer provided on an upper side of the base layer; and an aesthetic resinous layer with excellent design properties disposed on the upper side of the design print layer, the aesthetic resinous layer having a coating portion that is coated in a coating amount of 3.0 g/m² or more and less than 15.0 g/m², and micropores that are not coated and which are disposed surrounded by the coating portion.

A tenth aspect of the present invention is the decorative paper according to the ninth aspect, wherein the aesthetic resinous layer contains a heat-curable resin, an ultraviolet-curable resin, or an ionizing radiation-curable resin.

An eleventh aspect of the present invention is the decorative paper according to the tenth aspect, wherein the aesthetic resinous layer is disposed to match a design of the design print layer.

A twelfth aspect of the present invention is a decorative board including: the decorative paper according to any one of the ninth to eleventh aspects; and an impregnating resin that is impregnated and cured in the decorative paper.

A thirteenth aspect of the present invention is a method for producing a decorative board, comprising: a design printing step for forming a design print layer; and a resin coating step for forming an aesthetic resinous layer with excellent design properties, in which a coating amount of a coating portion is 3.0 g/m² or more and less than 15.0 g/m².

A fourteenth aspect of the present invention includes: the method for producing a decorative paper according to the thirteenth aspect; a resin impregnating step for impregnating the decorative paper with an impregnating resin; and a pressing step for curing the impregnating resin.

### Advantageous Effects of the Invention

According to the decorative paper, the decorative board, and the methods for producing the decorative paper and decorative board of the present invention, it is possible to provide a decorative paper and decorative board having excellent design properties, and processing suitability in a step of impregnating an impregnating resin, and methods for producing the decorative paper and decorative board.

### BRIEF DESCRIPTION OF THE DRAWINGS

FIG. 1A is a cross-sectional view schematically showing a configuration of a decorative paper according to a first embodiment.

FIG. 1B is a cross-sectional view schematically showing a configuration of the decorative paper according to the first embodiment.

FIG. 2A is a cross-sectional view schematically showing a configuration of a decorative board according to the first embodiment.

FIG. 2B is a cross-sectional view schematically showing a configuration of the decorative paper according to the first embodiment.

FIG. 3 is a flowchart showing a method for producing the decorative board according to the first embodiment.

FIG. 4 is a cross-sectional view schematically showing a configuration of a decorative paper according to a second embodiment.

FIG. 5 is a cross-sectional view schematically showing a configuration of a decorative board according to the second embodiment.

FIG. 6 is a flowchart showing an example of a method for producing the decorative board according to the second embodiment.

### DETAILED DESCRIPTION

### First Embodiment

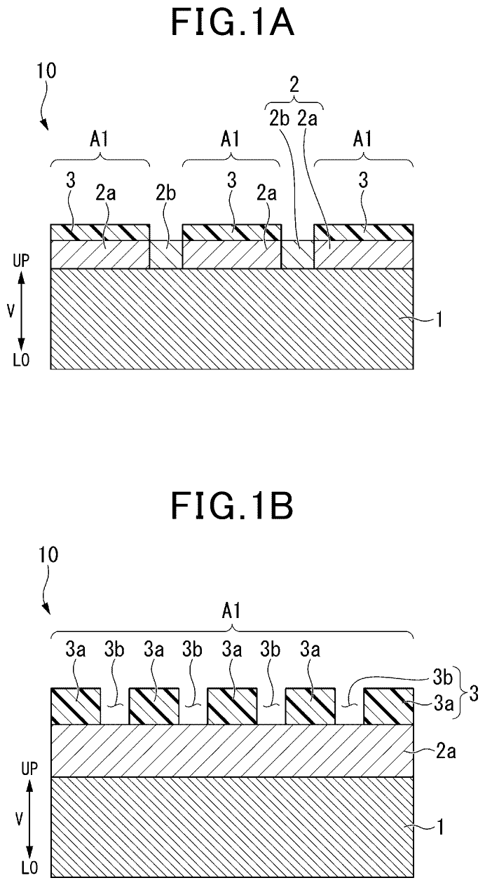

An embodiment of the present invention will be described with reference to FIGS. 1A to 3.

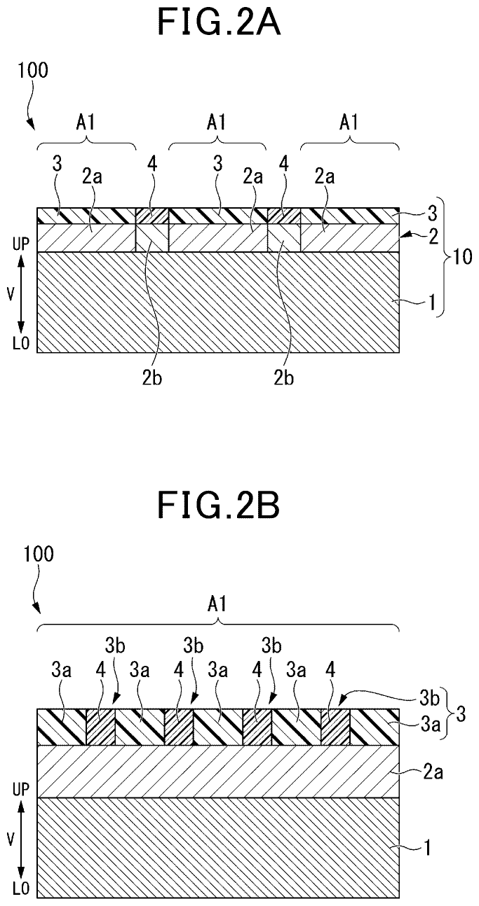

FIG. 1A is a cross-sectional view schematically showing a configuration of a decorative paper 10 according to the present embodiment. FIG. 1B is a cross-sectional view showing in an enlarged manner the coating area A1 in FIG. 1A, in which an aesthetic resinous layer 3 with excellent design properties described below has been coated. FIG. 2A is a cross-sectional view schematically showing a configuration of a decorative board 100, in which the decorative paper 10 has been impregnated with an impregnating resin 4. FIG. 2B is a cross-sectional view showing in an enlarged manner the coating area A1 in FIG. 2A, in which the aesthetic resinous layer 3 described below has been coated.

In the present embodiment, as shown in FIGS. 1A to 2B, the thickness direction of the decorative paper 10 and the decorative board 100 is defined as a “vertical direction V”, the side of the decorative paper 10 on which the base layer 1 is provided is defined as a “lower side LO” in the vertical direction V, and the opposite side to the lower side LO is defined as an “upper side UP” in the vertical direction V.

The decorative board 100 includes a decorative paper 10 and an impregnating resin 4. The decorative board 100 is formed by impregnating the decorative paper 10 with the impregnating resin 4, and then curing the impregnating resin 4 that has been impregnated. As a result of impregnating the decorative paper 10 with the impregnating resin 4, the impregnating resin 4 permeates and is cured inside the decorative paper 10. The decorative board 100 in which the impregnating resin 4 has been impregnated and cured has excellent properties, such as a high surface hardness, stain resistance, wear resistance, heat resistance, and water resistance.

The impregnating resin 4 is a known heat-curable resin used in a resin-impregnated decorative board. As the impregnating resin 4, a melamine-based resin, an epoxy-based resin, a diallyl phthalate-based resin, a benzoguanamine-based resin, a urethane-based resin, an alkyd-based resin, an unsaturated polyester-based resin, a phenol-based resin, a urea-based resin, and the like, can be used. The impregnating resin 4 is dissolved or dispersed in water to impregnate the decorative paper 10 as an aqueous impregnating liquid. As the impregnating resin 4, it is desirable to use a melamine resin, which has high strength, and excellent stain resistance, wear resistance, heat resistance, and water resistance.

The decorative paper 10 includes a base layer 1, a design print layer 2, and an aesthetic resinous layer 3 with excellent design properties.

The base layer 1 is a layer that is provided on the lower side LO of the decorative paper 10. The base layer 1 is a known fibrous sheet that can be impregnated with the impregnating resin 4. As the base layer 1, for example, titanium paper, tissue paper, fine paper, unbleached kraft paper, bleached kraft paper, and the like, can be used. As the base layer 1, it is desirable to use titanium paper, which has excellent printing suitability and resin impregnation suitability. The thickness of the base layer 1 is not particularly restricted, and a layer having a basis weight of 20 g/m² or more and 200 g/m² or less is generally used.

The design print layer 2 is a layer that is provided on the upper side UP of the base layer 1, and for example, can be formed by printing a wood grain, a stone grain, a sand grain, and the like. The design print layer 2 includes a first design forming portion 2a and a second design forming portion 2b. The first design forming portion 2a and the second design forming portion 2b form a design on the upper side UP of the base layer 1, for example, as a result of a pigment contained in a resin (ink) forming the first design forming portion 2a and a pigment contained in a resin (ink) forming the second design forming portion 2b having different colors. As the printing method of the design print layer 2, for example, known printing methods such as gravure printing, offset printing, flexographic printing, silk screen printing, or inkjet printing can be used. Furthermore, although a known printing ink that is suitable for the adopted printing method can be used as the design print layer 2, it is preferable to use a water-based ink. Compared with an oil-based ink, a water-based ink is more compatible with the aqueous solution of the impregnating resin 4, and rapid and uniform impregnation can be performed when the decorative paper 10 is impregnated with the impregnating resin 4, and further, excellent strength can be obtained by integration with the impregnating resin 4.

Furthermore, as the water-based ink used in the design print layer 2, it is desirable to use an ink in which the binder resin has casein or an emulsion resin as the main component. A binder resin having casein or an emulsion resin as the main component has the property of becoming less water-soluble when subjected to a drying step after printing of the ink, and in the step of impregnation with the impregnating resin 4, the binder resin is less likely to re-dissolve in the aqueous solution of the impregnating resin 4, making it less likely for the design pattern of the picture-printed layer 2 to be damaged, and further, contamination of the dissolved design print layer 2 with the impregnating resin 4 can be suppressed.

Examples of the emulsion resin contained in the binder resin include acrylic-based, vinyl acetate-based, styrene-based, and urethane-based emulsion resins. Furthermore, as the binder resin, in addition to casein or an emulsion resin, it is possible to use, for example, a combination of a water-soluble resin such as polyvinyl alcohol or polyacrylamide, and a water-soluble polymer such as a polysaccharide or a cellulose derivative, with the object of improving the stability of the ink.

The aesthetic resinous layer 3 is a layer that is provided on the upper side UP of the design print layer 2. As the aesthetic resinous layer 3, it is desirable to use a material that is transparent or semi-transparent such that the design of the design print layer 2 can be observed therethrough. As the aesthetic resinous layer 3, it is possible to use a heat-curable resin, an ultraviolet-curable resin, an ionizing radiation-curable resin, or a mixture thereof. As the aesthetic resinous layer 3, for example, a heat-curable resin such as a melamine-based resin, an epoxy-based resin, a urea-based resin, a phenol-based resin, an unsaturated polyester-based resin, a diallyl phthalate-based resin, a benzoguanamine-based resin, a urethane-based resin, an aminoalkyd-based resin, and a silicone-based resin, an ionizing radiation-curable resin such as a (meth)acrylate-based resin and an unsaturated polyester-based resin, and the like, can be used.

The aesthetic resinous layer 3 is provided on a portion on the upper side UP of the design print layer 2 and is disposed at a position that matches the design of the design print layer 2. In the present embodiment, the aesthetic resinous layer 3 is disposed at a position that overlaps the first design forming portion 2a when the decorative paper 10 and the decorative board 100 is viewed from the upper side UP. For example, in a case where the design of the design print layer 2 is a wood grain pattern, and the first design forming portion 2a forms a vessel portion of the wood grain pattern, the aesthetic resinous layer 3 is provided on the upper side UP of the vessel portion. As a result of providing the aesthetic resinous layer 3 at a position that matches the vessel portion, it is possible to impart a visual three-dimensional effect to the vessel portion.

As the method of forming the aesthetic resinous layer 3, known printing methods such as gravure printing, offset printing, flexographic printing, silk screen printing, or inkjet printing can be used. Furthermore, the aesthetic resinous layer 3 may be formed using a known coating device.

It is possible to subject the aesthetic resinous layer 3 to gloss adjustment, and impart a glossy appearance or matte appearance to the decorative paper 10 and the decorative board 100. Examples of methods of subjecting the aesthetic resinous layer 3 to gloss adjustment include a method of adding a matting agent to the aesthetic resinous layer 3. As a result of adding a matting agent, it is possible to perform gloss adjustment such that the aesthetic resinous layer 3 has low gloss (matte appearance). Furthermore, it is possible to perform gloss adjustment to obtain a high gloss (glossy appearance) by not adding a matting agent.

For example, in a case where the design of the design print layer 2 is a wood grain pattern, by adding a matting agent to the aesthetic resinous layer 3 provided to match the vessel portion (first design forming portion 2a) to obtain a low gloss, it is possible to impart a different gloss to the surface on the upper side UP of the design print layer 2 at the section on which the aesthetic resinous layer 3 is disposed (first design forming portion 2a) and the section on which the aesthetic resinous layer 3 is not disposed (second design forming portion 2b). As a result, the vessel portion of the wood grain pattern in which the aesthetic resinous layer 3 is disposed has a lower gloss compared to the section in which the aesthetic resinous layer 3 is not disposed, and by utilizing an optical illusion of the human eye, the visual three-dimensional effect can be further emphasized.

As a result of imparting a three-dimensional effect with the aesthetic resinous layer 3, it is possible to provide the decorative paper 10 and the decorative board 100 having excellent design properties. For example, in a case where a three-dimensional effect is imparted with the aesthetic resinous layer 3 to the vessel portion of a wood grain pattern, it is possible to provide the decorative paper 10 and the decorative board 100 having an appearance that is closer to that of natural wood.

Furthermore, the aesthetic resinous layer 3 includes a coating portion 3a and micropores 3b. As shown in FIGS. 1B and 2B, the coating area A1 on which the aesthetic resinous layer 3 is coated includes the coating portion 3a, which is actually coated and has the resin that forms the aesthetic resinous layer 3 disposed therein, and the micropores 3b that are not coated, in which the resin that forms the aesthetic resinous layer 3 is not disposed.

For example, in a case where the aesthetic resinous layer 3 is disposed in the vessel portion (first design forming portion 2a) of a wood grain pattern, the area of the vessel portion is the coating area A1. Generally, although the coating is performed with respect to the coating area A1 such that the resin is disposed in the entire area, as shown in FIG. 1B, the aesthetic resinous layer 3 has the micropores 3b, which are very small pores in which the resin is not disposed. The shape of the micropores 3b is not restricted, and the shape of the micropores 3b when the decorative paper 10 and the decorative board 100 are viewed from the upper side UP may be a dot shape or a continuous line shape. Furthermore, the micropores 3b that are disposed inside the coating area A1 may be regularly disposed, or irregularly disposed. Therefore, it is desirable that the micropores 3b are disposed such that the effect that the aesthetic resinous layer 3 imparts on the design of the decorative paper 10 and the decorative board 100 is minimized.

At this time, the proportion (area ratio) of the area in which the coating portion 3a is disposed to the area in which the design print layer 2 is disposed in the decorative paper 10 and the decorative board 100 is 5% or more and 60% or less. If the area ratio of the coating portion 3a to the design print layer 2 is less than 5%, the amount of resin that forms the aesthetic resinous layer 3 in the decorative paper 10 and the decorative board 100 becomes small, and the design properties become inferior. As a result of the area ratio being 5% or more, the resin that forms the aesthetic resinous layer 3 can be sufficiently disposed, and the decorative paper 10 and the decorative board 100 can be provided with excellent design properties.

In addition, when the aesthetic resinous layer 3 is formed on the upper side UP of the design print layer 2, a portion of the resin that forms the aesthetic resinous layer 3 permeates and soaks into the design print layer 2 and the base layer 1. If the resin that forms the aesthetic resinous layer 3 soaks into the design print layer 2 and the base layer 1, in the decorative board 100, the impregnation of the impregnating resin 4 into the decorative paper 10 is inhibited. If the impregnation of the impregnating resin 4 is inhibited, it takes time for the entire decorative paper 10 to be impregnated with the impregnating resin 4, and the processing suitability of the step of impregnating the impregnating resin 4 becomes inferior.

Here, as a result of the area ratio of the coating portion 3a to the design print layer 2 being 60% or less, it is possible to prevent the resin that forms the aesthetic resinous layer 3 from soaking into the design print layer 2 and the base layer 1, and sufficiently impregnate the decorative paper 10 with the impregnating resin 4. Furthermore, as shown in FIG. 2B, it is possible for the impregnating resin 4 to enter into the micropores 3b, and for the impregnating resin 4 to sufficiently soak into the decorative paper 10 via the micropores 3b. That is, as a result of the area ratio of the coating portion 3a to the design print layer 2 being 5% or more and 60% or less, it is possible to obtain the decorative paper 10 and the decorative board 100, which have both excellent design properties and processing suitability in the step of impregnating the impregnating resin 4.

For example, with respect to the coating area A1, in which the aesthetic resinous layer 3 such as a vessel portion of a wood grain pattern (first design forming portion 2a) is coated, in the aesthetic resinous layer 3, the amount of resin that forms the aesthetic resinous layer 3 is suppressed as a result of providing the micropores 3b. For this reason, in the coating area A1, the amount of resin that forms the aesthetic resinous layer 3 can be reduced without significantly changing the design. Consequently, it is possible to minimize the effect on the design properties of the decorative board 100, and improve the processing suitability of the step of impregnating the impregnating resin 4, and it is possible to achieve both design properties and processing suitability in the step of impregnating the impregnating resin 4.

Furthermore, the area ratio of the coating portion 3a to the design print layer 2 is preferably 10% or more and 40% or less. As a result of the area ratio being 10% or more, more of the resin that forms the aesthetic resinous layer 3 can be provided on the upper side UP of the design print layer 2, and the decorative paper 10 and the decorative board 100 can be provided with excellent design properties. Furthermore, as a result of the area ratio being 40% or less, it is possible to further prevent the resin that forms the aesthetic resinous layer 3 from soaking into the design print layer 2 and the base layer 1, and the processing suitability of the step of impregnating the impregnating resin 4 can be further improved.

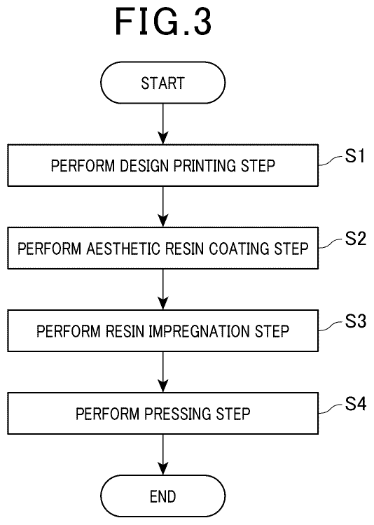

Next, the methods for producing the decorative paper 10 and the decorative board 100 will be described. FIG. 3 is a flowchart showing the steps by which the decorative paper 10 and the decorative board 100 according to the present embodiment are produced by a decorative board production system. Here, the decorative board production system is a system that performs the production of the decorative paper 10 and the decorative board 100 according to the present embodiment.

First, the decorative board production system performs step S1 (design printing step). In step S1, a design is printed on the upper side UP of the base layer 1 to form the design print layer 2.

Then, the decorative board production system performs step S2 (resin coating step for forming an aesthetic resinous layer). In step S2, the aesthetic resinous layer 3 is formed on the upper side UP of the design print layer 2 to obtain the decorative paper 10. At this time, of the first design forming portion 2a and the second design forming portion 2b forming the design of the design print layer 2, the aesthetic resinous layer 3 is formed on the upper side UP of the first design forming portion 2a. Furthermore, the area of the coating portion 3a in which the resin that forms the aesthetic resinous layer 3 is disposed (coated) is set such that the area ratio with respect to the area of the design print layer 2 is 5% or more and 60% or less. In the coating area A1, in which the aesthetic resinous layer 3 is to be disposed, by providing the micropores 3b, in which the resin that forms the aesthetic resinous layer 3 is not disposed (coated), it is possible to minimize the effect that the aesthetic resinous layer 3 imparts on the design properties, while also suppressing the amount of resin that forms the aesthetic resinous layer 3. In addition, because the area ratio of the coating portion 3a to the design print layer 2 is 5% or more, the aesthetic resinous layer 3 can have sufficient design properties. As a result, the design properties imparted by the aesthetic resinous layer 3 can be sufficiently maintained, while also suppressing the amount of resin that forms the aesthetic resinous layer 3.

Next, the decorative board production system performs step S3 (resin impregnating step). In step S3, the decorative paper 10 obtained in step S2 is impregnated with the impregnating resin 4. At this time, the impregnating resin 4 may be impregnated from the upper side UP of the decorative paper 10 or may be impregnated from the lower side LO. Furthermore, impregnation may be performed in a plurality of separate steps from the upper side UP or the lower side LO, or impregnation may be simultaneously performed from the upper side UP and the lower side LO.

In step S2, because the aesthetic resinous layer 3 is formed such that the area of the coating portion 3a becomes 60% or less with respect to the area of the design print layer 2, the resin that forms the aesthetic resinous layer 3 can be prevented from soaking into the design print layer 2 and the base layer 1, and it is possible for the decorative paper 10 to be sufficiently impregnated with the impregnating resin 4 in step S3.

Then, the decorative board production system performs step S4 (pressing step). In step S4, the decorative paper 10 impregnated with the impregnating resin 4 in step S3 is sandwiched by press plates, such as metal plates, from the upper side UP and the lower side LO, and the decorative paper 10 is pressed and heated from the upper side UP and the lower side LO. As a result of being pressed and heated, the heat-curable resin that forms the impregnating resin 4 is cured, and the decorative board 100 is formed. As the method of heating and pressing the decorative paper 10, it is possible to adopt a flat press method in which a metal plate is brought into contact with the paper, a circular pressure-type continuous lamination method, and the like.

Because the decorative board 100 obtained in step S4 has the area ratio of the coating portion 3a to the design print layer 2 of 5% or more and 60% or less, excellent design properties and processing suitability in the step for impregnating the impregnating resin 4 (resin impregnating step S3) are obtained.

According to the decorative paper 10, the decorative board 100, and the methods of producing the decorative paper 10 and the decorative board 100 of the present embodiment, the aesthetic resinous layer 3 that is formed on the upper side UP of the design print layer 2 has, in the coating area A1 in which the aesthetic resinous layer 3 is disposed, the coating portion 3a in which the resin that forms the aesthetic resinous layer 3 is disposed, and the micropores 3b in which the resin that forms the aesthetic resinous layer 3 is not disposed, and the area ratio of the coating portion 3a to the design print layer 2 is 5% or more and 60% or less.

Therefore, because it is possible to sufficiently maintain the design properties imparted by the aesthetic resinous layer 3, while also suppressing the amount of resin that forms the aesthetic resinous layer 3, it is possible to minimize the effect that the aesthetic resinous layer 3 imparts on the design properties, while also preventing the resin that forms the aesthetic resinous layer 3 from soaking into the design print layer 2, and the base layer 1 that is provided on the lower side LO of the design print layer 2. As a result, it is possible to provide the decorative paper 10 and the decorative board 100 having excellent design properties, and processing suitability in the step of impregnating the impregnating resin 4 (resin impregnating step S3) and in the methods for producing the decorative paper 10 and the decorative board 100.

The first embodiment of the present invention has been described above with reference to the drawings, but the specific configuration is not limited to the present embodiment and includes design changes and the like within a scope not departing from the spirit of the present invention. In addition, the components described in the first embodiment above, and the modifications described below, can be combined as appropriate.

### (Modification 1)

In the embodiment described above, although the decorative board 100 includes the decorative paper 10 and the impregnating resin 4, the form of the decorative board is not limited to this. The decorative board may be provided with a core paper or substrate on the lower side LO of the decorative paper 10.

As the core paper that is laminated on the lower side LO of the decorative paper 10, for example, titanium paper, bleached kraft paper, unbleached kraft paper, a glass fiber nonwoven fabric, and the like, can be used. Furthermore, a core paper that has been impregnated with the heat-curable resin may be laminated on the lower side LO of the decorative paper 10, and then pressed and heated. Examples of the heat-curable resin that can be used to impregnate the core paper include a melamine-based resin, an epoxy-based resin, a diallyl phthalate-based resin, a benzoguanamine-based resin, a urethane-based resin, an alkyd-based resin, an unsaturated polyester-based resin, a phenol-based resin, and a urea-based resin.

Furthermore, as the substrate that is laminated on the lower side LO of the decorative paper 10, it is possible to use a wooden substrate such as a particle board or a medium-density fiberboard (MDF), a metallic plate-shaped member such as aluminum or stainless steel, or a composite plate made of a core material consisting of a resin such as polyethylene, and having a metal such as aluminum bonded to both sides. In a case where the core paper or the substrate is laminated on the lower side LO of the decorative paper 10, the lamination may be performed via an adhesive agent. As a result of laminating the core paper or the substrate on the lower side LO of the decorative paper 10 and then forming the decorative board, it is possible to impart arbitrary properties to the decorative board, such as an improvement in rigidity or an adjustment to the thickness.

### (Modification 2)

In the embodiment described above, although the aesthetic resinous layer 3 is formed on the upper side UP of the first design forming portion 2a, the form of the aesthetic resinous layer 3 is not limited to this. The aesthetic resinous layer may be provided on the upper side UP of the second design forming portion 2b and does not have to be provided at a position that matches the design of the design print layer 2. For example, when the design of the design print layer 2 is a stone grain pattern, even if the aesthetic resinous layer is not disposed at a position that matches the design, a more realistic stone grain pattern can be realized as a result of imparting an irregular three-dimensional effect to the decorative paper 10 through the thickness of the aesthetic resinous layer in the vertical direction, and the low gloss.

The present invention will now be described in detail by way of the following examples. The invention should not be construed as being limited to the examples below.

### Example 1

As the base layer 1, titanium paper having a basis weight of 80 g/m² was prepared. The design print layer 2 having a design was formed on the upper side UP of the base layer 1, and a urethane-based ultraviolet-curable resin was formed as the aesthetic resinous layer 3 at a position that matches the design on the upper side UP of the design print layer 2. At this time, in the aesthetic resinous layer 3, the area ratio of the coating portion 3a to the design print layer 2 was set to 30%. In addition, the micropores 3b in the aesthetic resinous layer 3 were dot shaped. The ultraviolet-curable resin that forms the aesthetic resinous layer 3 was cured by irradiating ultraviolet light, thereby forming the decorative paper 10 of Example 1.

### Example 2

The decorative paper 10 of Example 2 was formed by the same method as in Example 1, except that the area ratio of the coating portion 3a to the design print layer 2 was set to 40%.

### Example 3

The decorative paper 10 of Example 3 was formed by the same method as in Example 1, except that the area ratio of the coating portion 3a to the design print layer 2 was set to 50%.

### Example 4

The decorative paper 10 of Example 4 was formed by the same method as in Example 1, except that the area ratio of the coating portion 3a to the design print layer 2 was set to 60%.

### Example 5

The decorative paper 10 of Example 5 was formed by the same method as in Example 1, except that the area ratio of the coating portion 3a to the design print layer 2 was set to 5%.

### Example 6

The decorative paper 10 of Example 6 was formed by the same method as in Example 1, except that the area ratio of the coating portion 3a to the design print layer 2 was set to 10%.

### Example 7

The decorative paper 10 of Example 7 was formed by the same method as in Example 1, except that a heat-curable resin was used as the aesthetic resinous layer 3.

### Example 8

The decorative paper 10 of Example 8 was formed by the same method as in Example 1, except that an electron beam-curable resin was used as the aesthetic resinous layer 3.

### Comparative Example 1

The decorative paper of Comparative Example 1 was formed by the same method as in Example 1, except that the area ratio of the coating portion to the design print layer was set to 70%.

### Comparative Example 2

The decorative paper of Comparative Example 2 was formed by the same method as in Example 1, except that the coating layer described in Example 1 of PTL 2 was formed between the design print layer and the aesthetic resinous layer.

### (Test 1)

The decorative paper of Examples 1 to 8 and Comparative Examples 1 and 2 were subjected to a design property evaluation test. In the design property evaluation test, 10 testers conducted a sensory test with respect to the design properties of the decorative paper and evaluated the level of appearance of the design with a focus on the effect of the micropores of the aesthetic resinous layer on the design properties.

The evaluation criteria consisted of three levels, with anything other than POOR being considered a pass.
EXCELLENT: 7 or more and 10 or fewer testers evaluated the design as having a good appearance
GOOD: 1 or more and 6 or fewer testers evaluated the design as having a good appearance
POOR: 0 testers evaluated the design as having a good appearance

### (Test 2)

The decorative paper of Examples 1 to 8 and Comparative Examples 1 and 2 were subjected to an impregnation property evaluation test. In the impregnation property evaluation test, the decorative paper cut into a 5 cm square was floated in a liquid melamine resin with the side laminated with the aesthetic resinous layer facing down, and the time taken for the melamine resin to soak into the entire surface on the side laminated with the base layer was evaluated.

The evaluation criteria consisted of three levels, with anything other than POOR being considered a pass.
EXCELLENT: Less than 20 seconds
GOOD: 20 seconds or more and less than 45 seconds
POOR: 45 seconds or more

### (Test 3)

The decorative paper of Examples 1 to 8 and Comparative Examples 1 and 2 were subjected to a surface property evaluation test. In the surface property evaluation test, the decorative paper was impregnated with a melamine resin as the impregnating resin, and the decorative board was formed by pressing and heating in a high-pressure press machine. A cotton pad soaked in methyl ethyl ketone (MEK) was reciprocated ten times over the surface of the formed decorative board on which the aesthetic resinous layer was laminated, and the degree of fading of the pattern of the design print layer was evaluated.

The evaluation criteria consisted of three levels, with anything other than POOR being considered a pass.
EXCELLENT: No fading of the design occurred
GOOD: Some color transfer occurs onto the cotton pad, but no fading of the design of the decorative board occurred
POOR: The design on the decorative board is noticeably faded

### (Test Results)

The results of tests 1 to 3 are shown in Table 1.

In Example 1 to 8, in which the area ratio of the coating portion to the design print layer was 5% or more and 60% or less, a good result was obtained in all of the tests. In Comparative Example 1, in which the area ratio of the coating portion to the design print layer was 70%, and in Comparative Example 2 having the coating layer, tests 2 and 3 were failed. Furthermore, in Examples 1 and 2, and 6 to 8, in which the area ratio of the coating portion to the design print layer was 10% or more and 40% or less, even better results were obtained.

TABLE 1

| | Test 1 | Test 2 | Test 3 |
|---|---|---|---|
| | Design property | Impregnation | Surface property |
| | evaluation | property evaluation | evaluation |
| Example 1 | EXCELLENT | EXCELLENT | EXCELLENT |
| Example 2 | EXCELLENT | EXCELLENT | EXCELLENT |
| Example 3 | EXCELLENT | GOOD | GOOD |
| Example 4 | EXCELLENT | GOOD | GOOD |
| Example 5 | GOOD | EXCELLENT | EXCELLENT |
| Example 6 | EXCELLENT | EXCELLENT | EXCELLENT |
| Example 7 | EXCELLENT | EXCELLENT | EXCELLENT |
| Example 8 | EXCELLENT | EXCELLENT | EXCELLENT |
| Comparative | EXCELLENT | POOR | POOR |
| Example 1 | | | |
| Comparative | EXCELLENT | POOR | POOR |
| Example 2 | | | |

### Second Embodiment

A second embodiment of the present invention will be described with reference to the drawings.

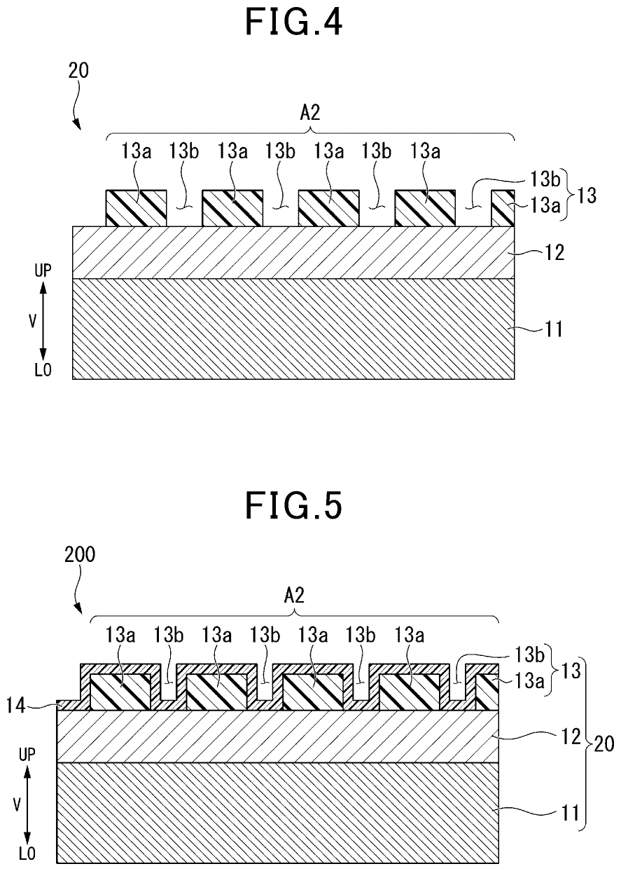

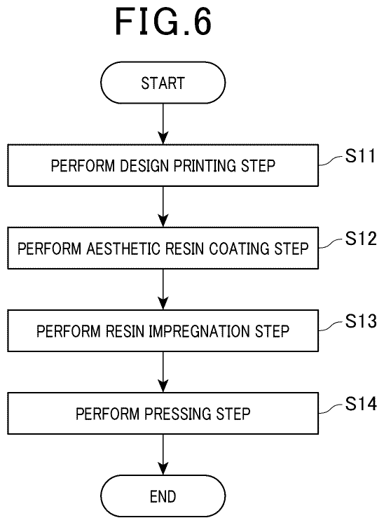

FIG. 4 is a cross-sectional view schematically showing a configuration of a decorative paper 20 according to the present embodiment. FIG. 5 is a cross-sectional view schematically showing a configuration of a decorative board 200, in which the decorative paper 20 has been impregnated with an impregnating resin 4.

In the present embodiment, as shown in FIGS. 4 and 5, the thickness direction of the decorative paper 20 and the decorative board 200 is defined as a “vertical direction V”, the side of the decorative paper 20 on which the base layer 1 is provided is defined as a “lower side LO” in the vertical direction V, and the opposite side to the lower side LO is defined as an “upper side UP” in the vertical direction V.

The decorative board 200 includes a decorative paper 20 and an impregnating resin 14. The decorative board 200 is formed by impregnating the decorative paper 20 with the impregnating resin 14, and then curing the impregnating resin 14 that has been impregnated. As a result of impregnating the decorative paper 20 with the impregnating resin 14, the impregnating resin 14 permeates inside the decorative paper 20, and further, as shown in FIG. 5, the impregnating resin 14 covers and is cured on the surface of the decorative paper 20. The decorative board 200 in which the impregnating resin 14 has been impregnated and cured has excellent properties, such as a high surface hardness, stain resistance, wear resistance, heat resistance, and water resistance.

The impregnating resin 14 is a known heat-curable resin used in a resin-impregnated decorative board. As the impregnating resin 14, a melamine-based resin, an epoxy-based resin, a diallyl phthalate-based resin, a benzoguanamine-based resin, a urethane-based resin, an alkyd-based resin, an unsaturated polyester-based resin, a phenol-based resin, a urea-based resin, and the like, can be used. The impregnating resin 14 is dissolved or dispersed in water to impregnate the decorative paper 20 as an aqueous impregnating liquid. As the impregnating resin 14, it is desirable to use a melamine resin, which has high strength, and excellent stain resistance, wear resistance, heat resistance, and water resistance.

The decorative paper 20 includes a base layer 11, a design print layer 12, and an aesthetic resinous layer 13 with excellent design properties.

The base layer 11 is a layer that is provided on the lower side LO of the decorative paper 20. The base layer 11 is a known fibrous sheet that can be impregnated with the impregnating resin 14. As the base layer 11, for example, titanium paper, tissue paper, fine paper, unbleached kraft paper, bleached kraft paper, and the like, can be used. As the base layer 11, it is desirable to use titanium paper, which has excellent printing suitability and resin impregnation suitability. The thickness of the base layer 11 is not particularly restricted, and a layer having a basis weight of 20 g/m² or more and 200 g/m² or less is generally used.

The design print layer 12 is a layer that is provided on the upper side UP of the base layer 11, and for example, can be formed by printing wood grain, stone grain, sand grain, and the like. As the printing method of the design print layer 12, for example, known printing methods such as gravure printing, offset printing, flexographic printing, silk screen printing, or inkjet printing can be used. Furthermore, although a known printing ink that is suitable for the adopted printing method can be used as the design print layer 12, it is preferable to use a water-based ink. Compared with an oil-based ink, a water-based ink is more compatible with the aqueous solution of the impregnating resin 14, and rapid and uniform impregnation can be performed when the decorative paper 20 is impregnated with the impregnating resin 14, and further, excellent strength can be obtained by integration with the impregnating resin 14.

Furthermore, as the water-based ink used in the design print layer 12, it is desirable to use an ink in which the binder resin has casein or an emulsion resin as the main component. A binder resin having casein or an emulsion resin as the main component has the property of becoming less water-soluble when subjected to a drying step after printing of the ink, and in the step of impregnation with the impregnating resin 14, the binder resin is less likely to re-dissolve in the aqueous solution of the impregnating resin 14, making it less likely for the design pattern of the picture-printed layer 12 to be damaged, and further, contamination of the dissolved design print layer 12 with the impregnating resin 14 can be suppressed.

Examples of the emulsion resin contained in the binder resin include acrylic-based, vinyl acetate-based, styrene-based, and urethane-based emulsion resins. Furthermore, as the binder resin, in addition to casein or an emulsion resin, it is possible to use, for example, a combination of a water-soluble resin such as polyvinyl alcohol or polyacrylamide, and a water-soluble polymer such as a polysaccharide or a cellulose derivative, with the object of improving the stability of the ink.

The aesthetic resinous layer 13 is a layer that is provided on the upper side UP of the design print layer 12. As the aesthetic resinous layer 13, it is desirable to use a material that is transparent or semi-transparent such that the design of the design print layer 12 can be observed therethrough. As the aesthetic resinous layer 13, it is possible to use a heat-curable resin, an ultraviolet-curable resin, an ionizing radiation-curable resin, or a mixture thereof. As the aesthetic resinous layer 13, for example, a heat-curable resin such as a melamine-based resin, an epoxy-based resin, a urea-based resin, a phenol-based resin, an unsaturated polyester-based resin, a diallyl phthalate-based resin, a benzoguanamine-based resin, a urethane-based resin, an aminoalkyd-based resin, and a silicone-based resin, an ionizing radiation-curable resin such as a (meth)acrylate-based resin and an unsaturated polyester-based resin, and the like, can be used.

As the method of forming the aesthetic resinous layer 13, known printing methods such as gravure printing, offset printing, flexographic printing, silk screen printing, or inkjet printing can be used. Furthermore, the aesthetic resinous layer 13 may be formed using a known coating device.

It is possible to subject the aesthetic resinous layer 13 to gloss adjustment and impart a glossy appearance or matte appearance to the decorative paper 20 and the decorative board 200. Examples of methods of subjecting the aesthetic resinous layer 13 to gloss adjustment include a method of adding a matting agent to the aesthetic resinous layer 13. As a result of adding a matting agent, it is possible to perform gloss adjustment such that the aesthetic resinous layer 13 has low gloss (matte appearance). Furthermore, it is possible to perform gloss adjustment to obtain a high gloss (glossy appearance) by not adding a matting agent.

Furthermore, the aesthetic resinous layer 13 may be provided on a portion on the upper side UP of the design print layer 12 and disposed at a position to match the design of the design print layer 12. For example, in a case where the design of the design print layer 12 is a wood grain pattern, the aesthetic resinous layer 13 is provided on the upper side UP of the vessel portion of the wood grain pattern. As a result, depending on the thickness of the aesthetic resinous layer 13 in the vertical direction V, it is possible to impart a three-dimensional feel to the vessel portion of the wood grain pattern. Furthermore, by adding a matting agent to the aesthetic resinous layer 13 to obtain a low gloss, it is possible to impart a different gloss (gloss difference) to the surface on the upper side UP of the design print layer 12 at the section on which the aesthetic resinous layer 13 is disposed and the section on which the aesthetic resinous layer 13 is not disposed. As a result, the vessel portion of the wood grain pattern in which the aesthetic resinous layer 13 is disposed has a lower gloss compared to the section in which the aesthetic resinous layer 13 is not disposed, and by utilizing an optical illusion of the human eye, it is possible to experience a visual three-dimensional effect.

As a result of imparting a tactile three-dimensional effect or a visual three-dimensional effect with the aesthetic resinous layer 13, it is possible to provide the decorative paper 20 and the decorative board 200 having excellent design properties. For example, in a case where a three-dimensional effect is imparted with the aesthetic resinous layer 13 to the vessel portion of a wood grain pattern, it is possible to provide the decorative paper 20 and the decorative board 200 having an appearance that is closer to that of natural wood.

Furthermore, the aesthetic resinous layer 13 includes a coating portion 13a and micropores 13b. As shown in FIGS. 4 and 5, the coating area A2 on which the aesthetic resinous layer 13 is coated includes the coating portion 13a, which is actually coated and has the resin that forms the aesthetic resinous layer 13 disposed therein, and the micropores 13b that are not coated in which the resin is not disposed. As shown in FIGS. 4 and 5, in the cross-sectional view of the decorative paper 20 or decorative board 200, the micropores 13b are disposed surrounded by the coating portion 13a in the board surface direction.

For example, in a case where the aesthetic resinous layer 13 is disposed in the vessel portion of a wood grain pattern, the area of the vessel portion is the coating area A2. Generally, although the coating is performed with respect to the coating area A2 such that the resin is disposed in the entire area, the aesthetic resinous layer 13 has the micropores 13b, which are very small pores in which the resin is not disposed. The shape of the micropores 13b is not restricted, and the shape of the micropores 13b when the decorative paper 20 and the decorative board 200 are viewed from the upper side UP may be a dot shape or a continuous line shape. Furthermore, the micropores 13b that are disposed inside the coating area A2 may be regularly disposed, or irregularly disposed. Therefore, it is desirable that the micropores 13b are disposed such that the effect that the aesthetic resinous layer 13 imparts on the design of the decorative paper 20 and the decorative board 200 is minimized.

At this time, the coating amount of the coating portion 13a is 3.0 g/m² or more and less than 15.0 g/m². If the coating amount of the coating portion 13a is less than 3.0 g/m², the amount of resin that forms the aesthetic resinous layer 13 in the decorative paper 20 and the decorative board 200 becomes small, and the design properties become inferior. As a result of the coating amount being 3.0 g/m² or more, the resin that forms the aesthetic resinous layer 13 can be sufficiently provided, and the decorative paper 20 and the decorative board 200 can be provided with excellent design properties.

In addition, when the aesthetic resinous layer 13 is formed on the upper side UP of the design print layer 12, a portion of the resin that forms the aesthetic resinous layer 13 permeates and soaks into the design print layer 12 and the base layer 11. If the resin that forms the aesthetic resinous layer 13 soaks into the design print layer 12 and the base layer 11, in the decorative board 200, the impregnation of the impregnating resin 14 into the decorative paper 20 is inhibited. If the impregnation of the impregnating resin 14 is inhibited, it takes time for the entire decorative paper 20 to be impregnated with the impregnating resin 14, and the processing suitability of the step of impregnating the impregnating resin 14 becomes inferior.

Here, as a result of the coating amount of the coating portion 13a being less than 15.0 g/m², it is possible to prevent the resin that forms the aesthetic resinous layer 13 from soaking into the design print layer 12 and the base layer 11, and sufficiently impregnate the decorative paper 20 with the impregnating resin 14. That is, as a result of the coating amount of the coating portion 13a being 3.0 g/m² or more and less than 15.0 g/m², it is possible to obtain the decorative paper 20 and the decorative board 200, which have both excellent design properties and processing suitability in the step of impregnating the impregnating resin 14.

For example, with respect to the coating area A2, in which the aesthetic resinous layer 13 such as a vessel portion of a wood grain pattern is coated, in the aesthetic resinous layer 13, the amount of resin that forms the aesthetic resinous layer 13 is suppressed as a result of providing the micropores 13b. For this reason, in the coating area A2, the amount of resin that forms the aesthetic resinous layer 13 can be reduced without significantly changing the design. Consequently, it is possible to minimize the effect on the design properties of the decorative board 200 and improve the processing suitability of the step of impregnating the impregnating resin 14, and it is possible to achieve both design properties and processing suitability in the step of impregnating the impregnating resin 14.

Next, the methods for producing the decorative paper 20 and the decorative board 200 will be described. FIG. 5 is a flowchart showing the steps by which the decorative paper 20 and the decorative board 200 according to the present embodiment are produced by a decorative board production system. Here, the decorative board production system is a system that performs the production of the decorative paper 20 and the decorative board 200 according to the present embodiment.

First, the decorative board production system performs step S11 (design printing step). In step S11, a design is printed on the upper side UP of the base layer 11 to form the design print layer 12.

Then, the decorative board production system performs step S12 (resin coating step for forming an aesthetic resinous layer). In step S12, the aesthetic resinous layer 13 is formed on the upper side UP of the design print layer 12 to obtain the decorative paper 20. At this time, the coating amount of the coating portion 13a, in which the resin that forms the aesthetic resinous layer 13 is disposed (coated), was set to 3.0 g/m² or more and less than 15.0 g/m². In the coating area A2, in which the aesthetic resinous layer 13 is to be disposed, by providing the micropores 13b, in which the resin that forms the aesthetic resinous layer 13 is not disposed (coated), it is possible to minimize the effect that the aesthetic resinous layer 13 imparts on the design properties, while also suppressing the amount of resin that forms the aesthetic resinous layer 13. In addition, because the coating amount of the coating portion 13a with respect to the design print layer 12 is 3.0 g/m² or more, the aesthetic resinous layer 13 can have sufficient design properties. As a result, the design properties imparted by the aesthetic resinous layer 13 can be sufficiently maintained, while also suppressing the amount of resin that forms the aesthetic resinous layer 13.

Next, the decorative board production system performs step S13 (resin impregnating step). In step S13, the decorative paper 20 obtained in step S12 is impregnated with the impregnating resin 14. At this time, the impregnating resin 14 may be impregnated from the upper side UP of the decorative paper 20, or may be impregnated from the lower side LO. Furthermore, impregnation may be performed in a plurality of separate steps from the upper side UP or the lower side LO, or impregnation may be simultaneously performed from the upper side UP and the lower side LO.

In step S12, because the aesthetic resinous layer 13 is formed such that the coating amount of the coating portion 13a is less than 15.0 g/m², the resin that forms the aesthetic resinous layer 13 can be prevented from soaking into the design print layer 12 and the base layer 11, and it is possible for the decorative paper 20 to be sufficiently impregnated with the impregnating resin 14 in step S13.

Then, the decorative board production system performs step S14 (pressing step). In step S14, the decorative paper 20 impregnated with the impregnating resin 14 in step S13 is sandwiched by press plates, such as metal plates, from the upper side UP and the lower side LO, and the decorative paper 20 is pressed and heated from the upper side UP and the lower side LO. As a result of being pressed and heated, the heat-curable resin that forms the impregnating resin 14 is cured, and the decorative board 200 is formed. As the method of heating and pressing the decorative paper 20, it is possible to adopt a flat press method in which a metal plate is brought into contact with the paper, a circular pressure-type continuous lamination method, and the like.

Because the decorative board 200 obtained in step S14 has the coating amount of the coating portion 13a of 3.0 g/m² or more and less than 15.0 g/m², excellent design properties and processing suitability in the step for impregnating the impregnating resin 14 (resin impregnating step S13) are obtained.

According to the decorative paper 20, the decorative board 200, and the methods of producing the decorative paper 20 and the decorative board 200 of the present embodiment, the aesthetic resinous layer 13 that is formed on the upper side UP of the design print layer 12 has, in the coating area A2 in which the aesthetic resinous layer 13 is disposed, the coating portion 13a in which the resin that forms the aesthetic resinous layer 13 is coated in a coating amount of 3.0 g/m² or more and 15.0 g/m² or less, and the micropores 13b that are not coated and which are disposed surrounded by the coating portion 13a.

Therefore, because it is possible to sufficiently maintain the design properties imparted by the aesthetic resinous layer 13, while also suppressing the amount of resin that forms the aesthetic resinous layer 13, it is possible to minimize the effect that the aesthetic resinous layer 13 imparts on the design properties, while also preventing the resin that forms the aesthetic resinous layer 13 from soaking into the design print layer 12, and the base layer 11 that is provided on the lower side LO of the design print layer 12. As a result, it is possible to provide the decorative paper 20 and the decorative board 200 having excellent design properties, and processing suitability in the step of impregnating the impregnating resin 14 (resin impregnating step S13), and the methods for producing the decorative paper 20 and the decorative board 200.

The second embodiment of the present invention has been described above with reference to the drawings, but the specific configuration is not limited to the present embodiment and includes design changes and the like within a scope not departing from the spirit of the present invention. In addition, the components described in the second embodiment above, and the modifications described below, can be combined as appropriate.

### (Modification 3)

In the embodiment described above, although the decorative board 200 includes the decorative paper 20 and the impregnating resin 14, the form of the decorative board is not limited to this. The decorative board may be provided with a core paper or substrate on the lower side LO of the decorative paper 20.

As the core paper that is laminated on the lower side LO of the decorative paper 20, for example, titanium paper, bleached kraft paper, unbleached kraft paper, a glass fiber nonwoven fabric, and the like, can be used. Furthermore, a core paper that has been impregnated with the heat-curable resin may be laminated on the lower side LO of the decorative paper 20, and then pressed and heated. Examples of the heat-curable resin that can be used to impregnate the core paper include a melamine-based resin, an epoxy-based resin, a diallyl phthalate-based resin, a benzoguanamine-based resin, a urethane-based resin, an alkyd-based resin, an unsaturated polyester-based resin, a phenol-based resin, and a urea-based resin.

Furthermore, as the substrate that is laminated on the lower side LO of the decorative paper 20, it is possible to use a wooden substrate such as a particle board or a medium-density fiberboard (MDF), a metallic plate-shaped member such as aluminum or stainless steel, or a composite plate made of a core material consisting of a resin such as polyethylene, and having a metal such as aluminum bonded to both sides. In a case where the core paper or the substrate is laminated on the lower side LO of the decorative paper 20, the lamination may be performed via an adhesive agent. As a result of laminating the core paper or the substrate on the lower side LO of the decorative paper 20 and then forming the decorative board, it is possible to impart arbitrary properties to the decorative board, such as an improvement in rigidity or an adjustment to the thickness.

The present invention will now be described in detail by way of the following examples. The invention should not be construed as being limited to the examples below.

### Example 9

As the base layer 11, titanium paper having a basis weight of 80 g/m² was prepared. The design print layer 12 having a design was formed on the upper side UP of the base layer 11. Furthermore, the aesthetic resinous layer 13 was formed by coating an ultraviolet-curable resin at a position that matches the design on the upper side UP of the design print layer 12. At this time, in the aesthetic resinous layer 13, the coating amount of the coating portion 13a was 11 g/m². In addition, the micropores 13b in the aesthetic resinous layer 13 were dot shaped. The ultraviolet-curable resin that forms the aesthetic resinous layer 13 was cured by irradiating ultraviolet light, thereby forming the decorative paper 20 of Example 9.

### Example 10

The decorative paper 20 of Example 10 was formed by the same method as in Example 9, except that a heat-curable resin was used as the aesthetic resinous layer 13.

### Example 11

The decorative paper 20 of Example 11 was formed by the same method as in Example 9, except that the coating amount of the coating portion 13a was set to 6.0 g/m².

### Example 12

The decorative paper 20 of Example 12 was formed by the same method as in Example 9, except that the coating amount of the coating portion 13a was set to 12.5 g/m².

### Comparative Example 3

The decorative paper of Comparative Example 3 was formed by the same method as in Example 9, except that the coating amount of the coating portion was set to 3.0 g/m².

### Comparative Example 4

The decorative paper of Comparative Example 4 was formed by the same method as in Example 9, except that the coating amount of the coating portion was set to 15.0 g/m².

### Comparative Example 5

The decorative paper of Comparative Example 5 was formed by the same method as in Example 9, except that the coating layer described in Example 1 of PTL 2 was formed between the design print layer and the aesthetic resinous layer.

### (Test 4)

The decorative paper of Examples 9 to 12 and Comparative Examples 3 to 5 were subjected to a design property evaluation test. In the design property evaluation test, ten testers conducted a sensory test with respect to the design properties of the decorative paper, and evaluated the level of appearance of the design with a focus on the effect of changing the coating amount of the aesthetic resinous layer on the design properties.

The evaluation criteria consisted of four levels, with anything other than POOR being considered a pass.
EXCELLENT: 10 or fewer testers evaluated the design as having a good appearance
GOOD: 7 or more and 9 or fewer testers evaluated the design as having a good appearance
FAIR: 4 or more and 6 or fewer testers evaluated the design as having a good appearance
POOR: 3 or fewer testers evaluated the design as having a good appearance

### (Test 5)

The decorative paper of Examples 9 to 12 and Comparative Examples 3 to 5 were subjected to an impregnation property evaluation test. In the impregnation property evaluation test, the decorative paper cut into a 5 cm square was floated in a liquid melamine resin with the side laminated with the aesthetic resinous layer facing down, and the time taken for the melamine resin to soak into the entire surface on the side laminated with the base layer was evaluated.

The evaluation criteria consisted of three levels, with anything other than POOR being considered a pass.
GOOD: Less than 20 seconds
FAIR: 20 seconds or more and less than 45 seconds
POOR: 45 seconds or more

### (Test 6)

The decorative paper of Examples 9 to 12 and Comparative Examples 3 to 5 were subjected to a surface property evaluation test. In the surface property evaluation test, the decorative paper was impregnated with a melamine resin as the impregnating resin, and the decorative board was formed by pressing and heating in a high-pressure press machine. A cotton pad soaked in methyl ethyl ketone (MEK) was reciprocated ten times over the surface of the formed decorative board on which the aesthetic resinous layer was laminated, and the degree of fading of the pattern of the design print layer was evaluated.

The evaluation criteria consisted of three levels, with anything other than POOR being considered a pass.
GOOD: No fading of the design occurred
FAIR: Some color transfer occurs onto the cotton pad, but no fading of the design of the decorative board occurred
POOR: The design on the decorative board is noticeably faded

### (Test Results)

The results of tests 4 to 6 are shown in Table 2.

In Examples 9 to 12, in which the coating amount of the coating portion was 3.0 g/m² or more and less than 15.0 g/m², a good result was obtained in all of the tests. In Comparative Example 3, in which the coating amount of the coating portion was less than 3.0 g/m², test 4 was failed. Furthermore, in Comparative Example 4, in which the coating amount of the coating portion was 15.0 g/m² or more, tests 5 and 6 were failed. In addition, in Comparative Example 5, in which the coating layer described in Example 1 of PTL 2 was formed between the design print layer and the aesthetic resinous layer, tests 5 and 6 were failed.

TABLE 2

| | Test 4 | Test 5 | Test 6 |
|---|---|---|---|
| | Design property | Impregnation | Surface property |
| | evaluation | property evaluation | evaluation |
| Example 9 | GOOD | GOOD | GOOD |
| Example 10 | GOOD | GOOD | GOOD |
| Example 11 | FAIR | GOOD | GOOD |
| Example 12 | GOOD | FAIR | FAIR |
| Comparative | POOR | GOOD | GOOD |
| Example 3 | | | |
| Comparative | GOOD | POOR | POOR |
| Example 4 | | | |
| Comparative | GOOD | POOR | POOR |
| Example 5 | | | |

### INDUSTRIAL APPLICABILITY

According to the decorative paper, the decorative board, and the methods for producing the decorative paper and decorative board of the present invention, it is possible to provide a decorative paper and decorative board having excellent design properties, and processing suitability in a step of impregnating an impregnating resin, and methods for producing the decorative paper and decorative board.

### REFERENCE SIGNS LIST

100, 200 Decorative board; 10, 20 Decorative paper; 1, 11 Base layer, 2, 12 Design print layer; 3, 13 Aesthetic resinous layer; 3a, 13a Coating portion; 3b, 13b Micropores; 4, 14 Impregnating resin; A1, A2 Coating area; S1, S11 Design printing step; S2, S12 Aesthetic resin coating step; S3, S13 Resin impregnating step; S4, S14 Pressing step; V Vertical direction; UP Upper side; LO Lower side.

What is claimed is:

1. A decorative paper, comprising:
a base layer;
a design print layer provided on an upper side of the base layer; and
an aesthetic resinous layer with excellent design properties disposed on an upper side of the design print layer, the aesthetic resinous layer having a coating portion that is coated in a coating area, and micropores that are not coated, in which an area ratio of the coating portion to the design print layer is 5% or more and 60% or less.

2. The decorative paper of claim 1, wherein
the aesthetic resinous layer contains a heat-curable resin, an ultraviolet-curable resin, or an ionizing radiation-curable resin.

3. The decorative paper of claim 2, wherein
the area ratio of the coating portion of the aesthetic resinous layer to the design print layer is 10% or more and 40% or less.

4. The decorative paper of claim 3, wherein
the aesthetic resinous layer is disposed to match a design of the design print layer.

5. A decorative board, comprising:
the decorative paper of claim 1; and
an impregnating resin that is impregnated and cured in the decorative paper.

6. A method for producing a decorative paper, comprising:
a design printing step for forming a design print layer; and
a resin coating step for forming an aesthetic resinous layer with excellent design properties, in which an area ratio of a coating portion to the design print layer is 5% or more and 60% or less.

7. The method for producing a decorative paper of claim 6, wherein
in the resin coating step, the aesthetic resinous layer is formed such that the area ratio of the coating portion of the aesthetic resinous layer to the design print layer is 10% or more and 40% or less.

8. A method for producing a decorative board, comprising:
the method for producing a decorative paper of claim 6;
a resin impregnating step for impregnating the decorative paper with an impregnating resin; and
a pressing step for curing the impregnating resin.

9. A decorative paper, comprising:
a base layer;
a design print layer provided on an upper side of the base layer; and
an aesthetic resinous layer with excellent design properties disposed on the upper side of the design print layer, the aesthetic resinous layer having a coating portion that is coated in a coating amount of 3.0 g/m² or more and less than 15.0 g/m², and micropores that are not coated and which are disposed surrounded by the coating portion.

10. The decorative paper of claim 9, wherein
the aesthetic resinous layer contains a heat-curable resin, an ultraviolet-curable resin, or an ionizing radiation-curable resin.

11. The decorative paper of claim 10, wherein
the aesthetic resinous layer is disposed to match a design of the design print layer.

12. A decorative board, comprising:
the decorative paper of claim 9; and
an impregnating resin that is impregnated and cured in the decorative paper.

13. A method for producing a decorative paper, comprising:
a design printing step for forming a design print layer; and
a resin coating step for forming an aesthetic resinous layer with excellent design properties, in which a coating amount of a coating portion is 3.0 g/m² or more and less than 15.0 g/m².

14. A method for producing a decorative board, comprising:
the method for producing a decorative paper of claim 13;
a resin impregnating step for impregnating the decorative paper with an impregnating resin; and
a pressing step for curing the impregnating resin.
